(19) United States
(12) Patent Application Publication
(10) Pub. No.: US 2008/0082708 A1
(43) Pub. Date: Apr. 3, 2008

(54) Token hold off for chipset communication

(76) Inventors: Kar Leong Wong, Perak (MY); Mikal Hunsaker, El Dorado Hills, CA (US); Rocio Candiotti, Sacramento, CA (US); Eric Thian Aun Tan, Penang (MY)

Correspondence Address: LEE & HAYES, PLLC, P.O. BOX 52050, MINNEAPOLIS, MN, 55402, US

(21) Appl. No.: 11/540,434

(22) Filed: Sep. 29, 2006

(51) Int. Cl. G06F 13/00

(52) U.S. Cl. 710/111

(57) ABSTRACT

Embodiments of token hold off techniques for a token based communication interconnect are presented herein.

### BACKGROUND

The pervasiveness of computing devices is ever increasing. For example, users may utilize a wide range of devices, such as desktop personal computers, laptop computers, personal digital assistants (PDAs), wireless phones, wireless routers, wireless access points (WAPs), and so on. Chipsets employed with these devices are becoming increasingly more powerful and complex, and may have a variety of interconnected components such as a processor, memory hub, memory, input/output hub, and various other devices. Operation and management of these components may involve communications back and forth between the various components, and between host systems via a network.

One traditional technique for this communication between components in a chipset and networked systems was to use the main chipset interconnects of the host systems for both normal operations and management functions. However, management of a network of host systems via main chipset interconnects typically uses full system power, which may expose the host system to security threats, and may not be available once the host system has been powered down.

### BRIEF DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is an illustration of an exemplary implementation of an environment that is operable to employ token hold off techniques.

FIG. 2 is an illustration of an exemplary implementation showing an interconnected device of FIG. 1 in greater detail.

FIG. 3 is a flow diagram depicting a procedure in an exemplary implementation in which a token hold off techniques is employed to delay release of a token.

FIG. 4 is an illustration of an exemplary implementation of a controller operable to perform token hold off techniques.

FIG. 5 an illustration of an exemplary implementation depicting token hold off logic which may be employed by a controller of FIG. 5 in greater detail.

### DETAILED DESCRIPTION

In the following discussion, an exemplary environment and devices are described which may provide and/or utilize techniques to accomplish a token hold off mechanism for a chipset. In one embodiment, a token hold off mechanism is described for a token based half-duplex communication link between a pair of devices provided in a chipset which may favorably improve the efficiency of the communication link. Exemplary procedures are then described which may be employed by the exemplary environment and/or devices, as well as by other environments and/or devices without departing from the spirit and scope thereof.

Exemplary Devices

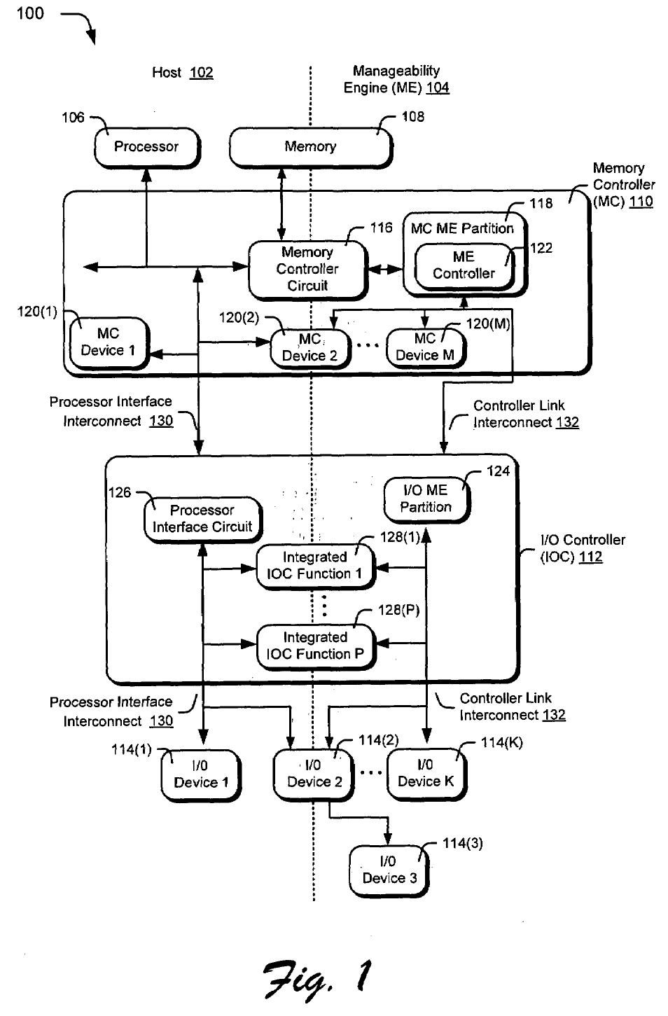

FIG. 1 illustrates an exemplary implementation of an environment 100 that is operable to employ token hold off techniques described herein. The environment 100 may be partitioned into a host subsystem 102 and a manageability engine (ME) subsystem 104. The environment 100 includes a processor unit 106, a memory 108, a memory controller (MC) 110, an input/output controller (10C) 112, and a plurality of input/output (I/O) devices 114(1) to 114(K). The I/O devices 114(1) to 114(K) may include any I/O devices to perform I/O functions, examples of which include controllers for input devices (e.g., keyboard, mouse, trackball, pointing device), media cards (e.g., audio, video, graphic), network cards and any other peripheral controllers, LAN cards, and so forth.

The host subsystem 102 includes components that are operated in a normal environment, e.g., host system computing functions. The ME 104 may be implemented as a complete subsystem embedded into the host subsystem 102 and integrated to provide isolated system management and firmware-based system features for the platform. The ME 104 normally may not access the resources of the host subsystem 102 and the host subsystem 104 may not access the ME resources. However, the ME 104 may share a few resources with the host subsystem 102 in a secure manner. These shared resources prevent unsecured access between the ME 104 and the host partitions to effectively isolate the ME 104 from the host subsystem 102.

The processor unit 106 represents a central processing unit of any type of architecture, such as processors using hyper threading, security, network, digital media technologies, single-core processors, multi-core processors, embedded processors, mobile processors, micro-controllers, digital signal processors, superscalar computers, vector processors, single instruction multiple data (SIMD) computers, complex instruction set computers (CISC), reduced instruction set computers (RISC), very long instruction word (VLIW), or hybrid architecture. The main memory 108 stores system code and data. The main memory 108 is typically implemented with dynamic random access memory (DRAM), static random access memory (SRAM), or any other types of memories including those that do not need to be refreshed. The main memory 108 may include multiple channels of memory devices such as DRAMs. The DRAMs may include Double Data Rate (DDR2) devices.

The memory controller (MC) 110 is a chipset to provide control and configuration of memory and input/output devices such as the memory 108 and the IOC 112. The MC 110 includes a memory control circuit 116, MC ME partition 118, and a plurality of MC devices 120(1) to 120(M), which may be integrated with the MC 110 or provided as separate units interconnected with the MC 110. The MC 110 may be integrated into a chipset that integrates multiple functionalities such as graphics, media, isolated execution mode, host-to-peripheral bus interface, memory control, power management, for instance using MC devices 120(1) to 120(M) configured in a variety of ways. The MC 110 or the memory controller functionality in the MC 110 may also be integrated in the processor unit 106. In some embodiments, the MC 110, either internal or external to the processor unit 106, may work for each of the cores or processors in the processor unit 106. In other embodiments, it may include different portions that may work separately for different cores or processors in the processor unit 106. The memory control circuit 116 provides memory control functionalities as well as other control functions. The MC ME partition 118 is a part of the ME 104 subsystem. It may share the memory control circuit 116 with the host 102 subsystem in a secure manner. The MC ME 118 includes at least a ME controller 122 and may also include other components such as associated memory, an encryption/decryption module to permit secure communication, and so forth. The ME controller 122 is a processor or a controller that may execute to perform, manage and control the manageability functions of the ME 104 subsystem.

The Input/Output Controller (10C) 112 provides functionalities that are designed to support I/O functions. The IOC 112 may also be integrated into a chipset together or separate from the MC 110 to perform I/O functions. The IOC 112 includes an I/O ME partition 124, a processor interface circuit 126, and a plurality of integrated IOC functions 128(1) to 128(P). I/O ME partition 124 manages manageability functions of the ME 104 for the IOC 112, and may also manage secure communications between IOC 112 portions of the ME 104 and the host subsystem 102. IOC functions 128(1) to 128(P) represent a variety of interfaces, logic, devices and so forth which may be included with the IOC 112 such as peripheral component interconnect (PCI) bus interface, processor interface, interrupt controller, direct memory access (DMA) controller, power management logic, timer, counter, storage, memory, system management bus (SMBus), universal serial bus (USB) interface, mass storage interface, low pin count (LPC) interface, wireless interconnect, direct media interface (DMI), and forth.

The partitioned environment 100 is depicted as including two independently operable and powered communications interconnect systems, which are a processor interface interconnect 130 and a controller link interconnect 132 corresponding to the host 102 and ME 104 subsystems respectively. In the host 102 subsystem, the processor interface interconnect 130 provides an interface to peripheral devices for interaction with the processor 106, memory 108, and other devices. Processor interface interconnect 130 represents the primary high speed, high power interconnects between devices such as those employed in traditional computing chipsets. In one embodiment, the processor interface interconnect 130 is a direct media interface (DMI) interconnect or link. The processor interface interconnect 130 may: be point-to-point or connected to multiple devices (bussed). It is contemplated that the processor interface interconnect 130 may include a variety of interconnect or bus technology such as Peripheral Component Interconnect (PCI), PCI Express (PCIe), Universal Serial Bus (USB), Small Computer System Interface (SCSI), serial SCSI, and Direct Media Interface (DMI), and so forth, individually or in combinations.

As noted, the ME 104 represents an isolated subsystem operable to provide management functions independent of the host 102 subsystem. For instance, the ME 104 may integrate functionality to discover (asset inventory tracking), heal (updates/remote troubleshooting) and protect (secure access and protection tools) networked computing resources. The functions of the ME 104 are accessible out-of-band allowing remote platform management regardless of the system or operating system state. The ME 104 functionality is designed to operate out-of-band and independent of the system power state. Traditionally employed high speed serial interfaces such as DMI, PCI, PCIe, and the like, are not well suited for the ME 104 interconnects, because they have relatively high power consumption, may not function on auxiliary power, may be occupied with normal host 102 activities, and are not securely isolated from the hosts system 102.

Accordingly, a controller link (c-link) interconnect 132 system is employed for interconnects in the ME 104. The c-link interconnect 132 system is configured to provide communication links between devices in the ME 104 and may include numerous individual links between pairs of devices, for instance between the MC 110 and IOC 112, between pairs of MC 120 and I/O devices 114, between the IOC and I/O devices 114 and so forth. The c-link interconnect 132 typically consumes very low power, such that it may operate on auxiliary power. It may also have a low pin count to permit routing through reserved pins of existing connectors and to minimize cost, as well as have independent clocking. Typically, a medium bandwidth ranging from 8 Megabits per second (Mbps) to 66 Mbps is employed since existing lower speed buses (e.g., SmBus) may be insufficient for the functions of ME 104, while higher speed serial interfaces (such as PCIe) may exceed the amount of bandwidth consumed by ME 104. However, it should be apparent that such other bandwidths are also contemplated in other embodiments.

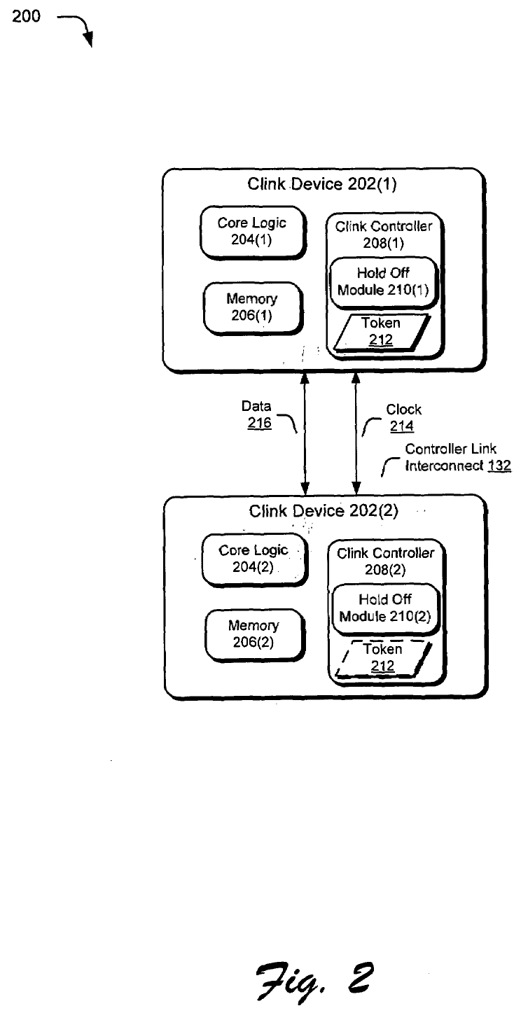

Thus, the c-link interconnect 132 system is a low power “always on” bus that operates parallel to the processor interface interconnect 130 and is used for transactions between devices in the ME subsystem 104. The processor interface interconnect 130 independently operates for transactions between devices in the host 102 system space, such as for PCI transactions when the process or interface interconnect 130 is configured as a PCIe interconnect. Certain devices may be shared in both the Host 102 and ME 104 subsystems, for example I/O device 2 114(2), memory controller circuit 116, and other devices depicted as bridging the subsystems in FIG. 1. These device may be interfaced to both the processor interface interconnect 130 and c-link interconnect 132. In an implementation, the c-link interconnect 132 system uses token based half-duplex communication in which interconnected pairs of devices pass a token to control ownership of the associated linked. A c-link controller provided with one or more of a pair of interconnected devices may be configured to manage traffic (packets) between the devices. The c-link controller may also include functionality for a token hold off mechanism to more efficiently perform communication, further discussion of which may be found in reference to the following discussion of FIGS. 2-5.

Referring to FIG. 2, an exemplary implementation 200 is depicted of a c-link interconnect between one pair of c-link devices 202(1) and 202(2) via the c-link interconnect 132 system. Each of the c-link devices 202(1), 202(2) is depicted as including a respective core logic 204(1), 204(2); memory 206(1), 206(2); and c-link controller 208(1), 208(2). The c-link devices 202(1), 202(2) may be any of the individual devices depicted in FIG. 1 as interconnected via c-link interconnect 132 system or a variety of other devices. Thus, the core logic 204(1), 204(2) may be configured to provide a wide variety of device specific functionality, associated with MC devices 120, I/O devices 114, controllers 110,112 and so forth. It is noted the ME 104 subsystem of FIG. 1 is but one tangible example of a variety of contemplated subsystems in which c-link interconnect 132 techniques may be employed. For instance, c-link interconnects 132 described herein may be applied as a primary or secondary communication interconnect in various host electronics systems including but not limited to chipsets, personal computers, handheld devices, game appliances, set-top boxes, embedded microcontroller devices, and so forth, without departing from the spirit and scope thereof.

C-link controllers 208(1), 208(2) represent functionality to manage traffic (data packets) for a respective device and between the paired c-link devices 202(1), 202(2); to arbitrate token ownership; to detect, receive, process, and transmit communications via clink interconnect 132; and so forth. Thus, c-link controllers 208(1), 208(2) are generally operable to manage communication between the interconnected devices and packet flow control to the respective core logic 204, and/or other device specific functionality. As noted c-link interconnect 132 system may employ token based half-duplex communication in which interconnected pairs of devices pass a token 212 back and forth to control ownership of the associated link, e.g., to determine which device may transmit on the point to point interconnect between the pair of devices. In one embodiment, 2 pins and/or signals are involved to communicate between interconnected devices, a clock (MLCLK 214) and a data (MLDATA 216) signal. In operation, a single device is allowed to transmit at a particular time. The token 212 is passed between the two c-Link devices for ownership to transmit data on the MLCLK 212 and MLDATA 214 signal lines. In FIG. 2 for example device 202(1) is depicted as the current token 212 holder. Token 212 is also illustrated in phantom as being held by the opposite device 202(2) to represent that the token 212 may pass between the pair of devices, 202(1), 202(2).

One traditional technique used in token-based communications is for a device to immediately or almost immediately pass the token 212 to the opposite device when it has no data to transmit (e.g., when idle). Thus, the token 212 may “ping-pong” back and forth between a pair of interconnected devices until one of them has data to transmit. After a set number of cycles of the token 212 being passed from the upstream device to the downstream device, and then back to the upstream device, the c-link interconnect 132 may be configured to go into a low power state to conserve power. During this low power state, either c-link device 202(1), 202(2) of the link that has data to send may initiate a link wake process in order to go back to normal power. However, the token passing and the link wake process consumes bandwidth and promotes latency in the c-link channel.

Token hold off techniques are introduced herein which may minimize token passing and the link wake up events, and correspondingly increases the efficiency of the c-link interconnect 132 system. In general, the token hold off techniques are employed to anticipate when a device will have data to send and delay releasing the token. In an implementation, c-link controllers 208(1), 208(2) are further configured to perform token hold off techniques via respective hold off modules 210(1), 210(2) depicted in FIG. 2. The hold off modules 210(1), 210(2) represent functionality which may be integrated with a respective device and/or controller and which is operable to determine/detect a variety of hold-off conditions to maintain ownership of the token 212 (e.g., control of the interconnect), even when there is no immediate data to send.

For instance, when a c-link device 202(1) does not currently have data to transmit or is idle, the hold-off module 210(1) may operate to anticipate that data packets for transmission will be available after a short duration, and thus maintains the token 212 and control of the clink interconnect 132 rather than immediately releasing the token 212 to the opposite device. A c-link device may be allowed to hold off the token for a defined number of clocks, which improves efficient operation of the link. In an implementation, the token hold off period is configurable between 8 and 32 idle bytes. If the token 212 has been held off more than the defined token hold off period without sending data, the token 212 is back to the opposite c-link device. Further, discussion of token hold off techniques, the operation of c-link controllers 208(1), 208(2), and exemplary hold off conditions may be found in relation to the following figures.

Generally, any of the functions described herein can be implemented using software, firmware, hardware (e.g., fixed logic circuitry), manual processing, or a combination of these implementations. The terms “module,” “functionality,” and “logic” as used herein generally represent software, firmware, hardware, or a combination thereof. In the case of a software implementation, for instance, the module, functionality, or logic represents program code that performs specified tasks when executed on a processor (e.g., CPU or CPUs). The program code can be stored in one or more computer readable memory devices, e.g., memory 208. The features of the techniques described below are platform-independent, meaning that the techniques may be implemented on a variety of commercial computing platforms having a variety of processors.

Exemplary Procedures

The following discussion describes token hold off techniques that may be implemented utilizing the previously described systems and devices. The procedures are shown as a set of blocks that specify operations performed by one or more devices and are not necessarily limited to the orders shown for performing the operations by the respective blocks.

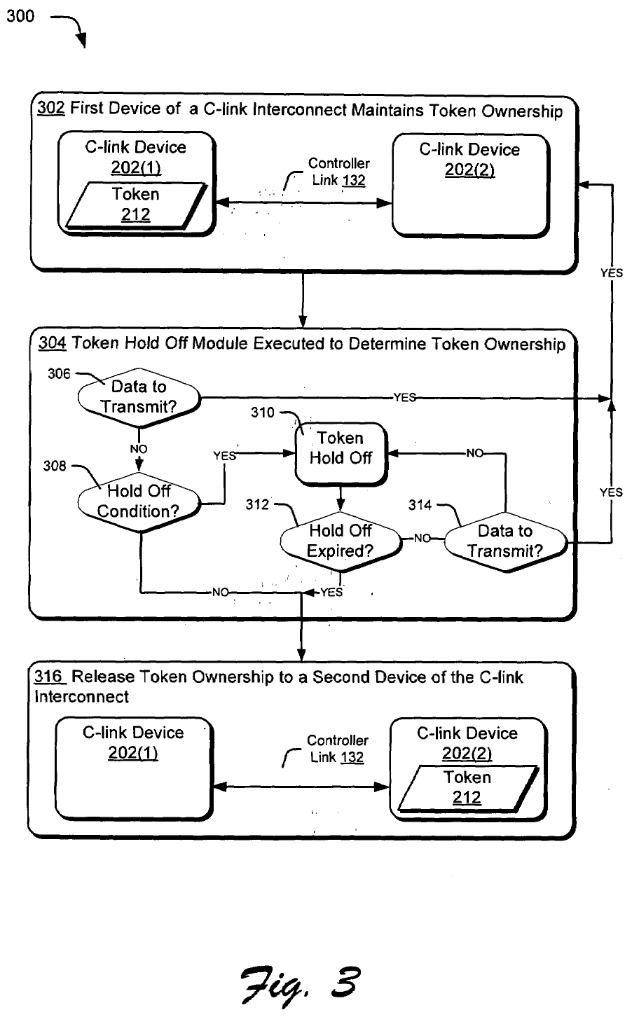

FIG. 3 depicts a flow diagram of a procedure 300 in an exemplary implementation in which a token hold off techniques may be employed to delay token release. The token is owned by a first device (block 302). For instance, FIG. 3 depicts c-link device 202(1) as initially owning/maintaining the token 212. The token 212 may have passed from the opposite c-link device 202(2) in normal operations. Typically, the upstream device (e.g., closest in the hierarchy to the processor 106) will have the token 212 at start-up or on occurrence of a reset condition, thus the token 212 may also have been obtained in this manner. C-link device 202(1) accordingly has ownership to transmit data on the c-link interconnect 132 signal lines.

Token hold off module is executed to determine token ownership (block 304). For instance, c-link device 202(1) may execute hold off module 210(1), which may be implemented as software, firmware, hardware and so forth. The hold off module 210(1) may be implemented as a component of a c-link controller 208(1) associated with the c-link device 202(1), as a stand alone module, as a separate device and so forth. Based on execution of the hold-off module 210(1) the ownership of the token may be passed to the opposite c-link device 202(2) or the token may be maintained by the first device 202(1). The hold off logic represented by block 304 of FIG. 3 may be configured in a variety of ways to determine when and/or if the token 212 will be passed, one embodiment of which is illustrated by the additional blocks within block 304.

In an embodiment, hold off logic may include a determination of whether the token owing device currently has data to transmit (block 306). For instance, if core logic 204(1) of c-link device 202(1) in FIG. 2 has completed various transactions, it may have data packets for communication to the opposite c-link device (e.g., a transmission queue). Thus, the hold off module 210(1) may determine that data packets are ready to be transmitted and the token 212 (and corresponding ownership of the interconnect) remains with the first device (block 302). When there is no data to transmit, then the hold off logic may proceed to an identification and/or determination of one or more hold off conditions (block 308). When one or more hold off conditions are present, the token hold off occurs (block 310).

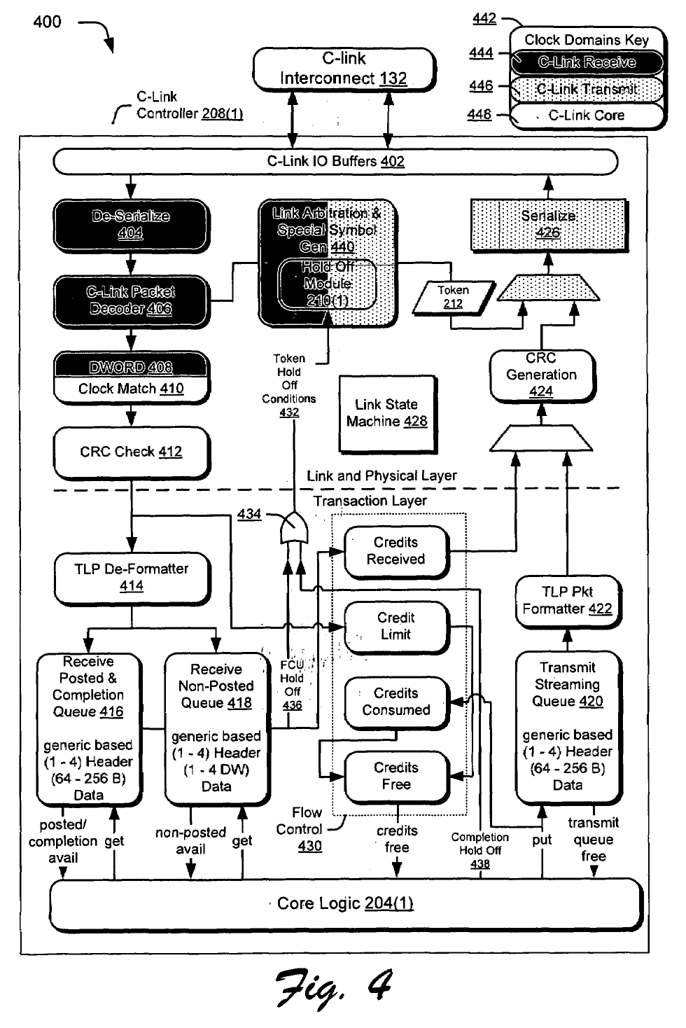

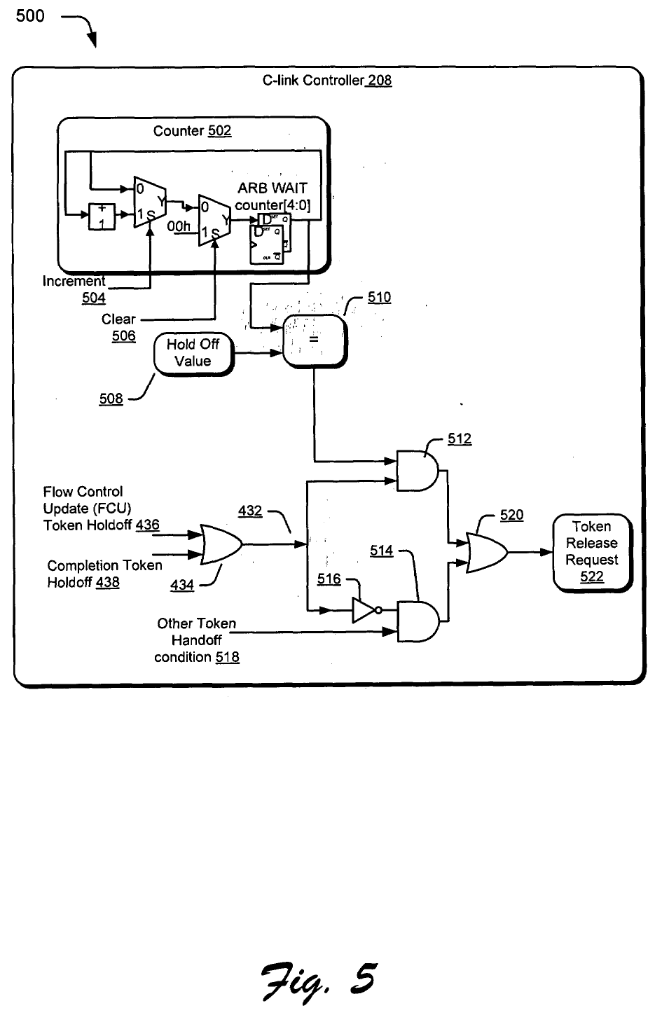

For instance, the hold-off module 210(1) may be operable to understand or anticipate when there are transactions set to occur which will after a short duration result in data and/or packets to transmit, such as by examining pending or in progress transactions, a transaction/request queue of the device 202(1), the activity of the core logic 204(1), and so forth. When such transactions, activities and so forth are anticipated by the hold-off module 210(1), the associated c-link device 202(1) may be permitted to hold off token 212 release for a defined number of clocks as previously described. During the token hold-off period, the first c-link device 202(1) maintains the token 212. A variety of holds off conditions may be defined, the presence of which may be determined by a hold-off module 210(1) to permit a device to hold off token release when the device doe not have current data to transmit, examples of which include but are not limited to pending flow control updates (FCU) and pending completions, further discussion of may be found in relation to the following discussion of FIGS. 4-5.

The hold off logic may further include functionality to track the hold off period, such as a timer, counter and so forth. A determination may be made when the defined hold off period expires (block 312). While the period has not yet expired, the token 212 is maintained by the first device 202(1) and a determination may once again be made whether the first device has data to send (block 314). For example, the hold off module 210(1) may detect data output from the pending transaction (e.g., a hold off condition) of the core logic 204(1) which caused the hold off to occur. When data is detected, the token hold off may be terminated and the first device 202(1) has token ownership as in block 302. Subsequently, the hold off logic may again be executed as in block 304, such as at regular intervals, on demand and so forth. When, however, there is no current data to send in block 314, then the token hold off may persist (block 310) for the predetermined hold off period. When the period of time for the hold off has expired, the token ownership is released to the opposite c-link device (block 316). In an implementation, the token release occurs at the time-out of the hold-off period regardless of whether the expected transaction initiating the hold-off period actually was completed and/or produced data to transmit. Further, the hold-off module 210(1) may be configured such that a single hold off period is run before passing of the token 212, to prevent a single device from monopolizing the token 212 for an extended period of time. Thus, once the hold off is initiated, the token hold off (block 310) may persist until the expiration of the defined period of time or until data is produced to be transmitted.

Returning now to block 308, if there is no hold off conditions identified or determined, the token is released to the second device e.g., the opposite c-link (block 316). In other words, the token 212 in the continuing example may be released by the first c-link device 202(1) immediately or almost immediately when there is no data to transmit and no hold off condition. Naturally, when the second device 202(2) has token ownership (block 316), the same or similar hold-off logic (e.g., an associated hold off module 210(2)) may be executed to determine when and/or if the token is released back to the first c-link device 202(1). In this manner, token hold off techniques may be employed to pass a token back and forth between a pair of device to designate ownership (e.g., ability to transmit) of a c-link interconnect 132.

FIG. 4 depicts an exemplary implementation 400 of a c-link controller 208(1) operable to employ one or more token hold off techniques described herein. The c-link controller 208(1) may be incorporated into any of the previously described devices (as well as other devices) and may be configured to interconnect with other devices via a c-link interconnect 132 system as depicted in FIG. 1. In FIG. 4, the c-link controller 208(1) is depicted as interfaced to the c-link interconnect 132 system through which the controller 208(1) and an associated device may receive data packets communicated from an opposite c-link device. The packets may be transmitted as bit by bit data which is received by Input/Output (I/O) buffers 402. The buffered bit by bit data may be communicated to a de-serialize 404 portion to accumulate data packets of a particular byte size such as 8 bits, 16 bits and so forth. Then, a packet decoder 406 may operate to determine the type of packet, detect special packets, and to route packets within controller 202. For instance, ordinary data packets may be sent for consumption by the core logic 204, while token packets or other special packets may be forwarded to other components of the controller 208(1), such as link arbitration portion 440 which is described further below.

A dword 408 portion may operate to accumulate even larger data packets. For instance, a dword may correspond to 32 bits or other configurable aggregated size of the received data. A clock match 410 portion is provided to match the clock speed of received packets to a desired speed, typically that of the core logic 204(1). Next a cycle redundancy check 412 portion performs a redundancy check on the received data. The data passes from the link and physical layer to the transaction layer, which logically separate core device transactions from the communication link functions of the controller 208(1). In the transaction layer, a transaction layer packet (TLP) deformatter 414 decodes packets, in particular decoding the headers to determine the type of packet and/or request. The packets may then be added to appropriate queues in preparation for processing by the core logic 204(1). FIG. 4 illustrates a posted and completion queue 416 and a non-posted request queue 418. The queues 416, 418 may each have associated buffer size.

Upon processing of the packets, the core logic 204(1) may generate data (packets, requests, completions, and so forth) to transmit via the link 132. The outgoing data is sent first to a transmission queue 420, then may be formatted by a transaction layer packet (TLP) packet formatter 422 into packets for communication to the opposite c-link device. Passing back into the link and physical layer, a cycle redundancy check (CRC) generation 424 portion generates redundancy data which permits a CRC by the opposite device receiving the packets. The packets, are then transformed by serialize 426 portion for bit by bit transmission via the c-link interconnect 132 to the opposite c-link device. A link state machine 428 is also depicted which may manage operation in the link layer, initialization of the controller 208(1), operation of the power state of the controller 208(1) such as between operational power and low power state, wake-up from low power and so forth.

In an implementation, the controller 208(1) utilizes a credit based flow control 430 system to manage data flow between a pair of devices interconnected via the c-link interconnect 132. Those skilled in the art will appreciate that credit based flow control 430 system involves the linked devices passing flow control packets and credits back and forth to indicate the amount of available space in their queues, and in order to keep track of a credit limit, the number of credits received, the credits consumed (e.g. transmitted), and accordingly to determine the number of credits free, e.g. how many packets may be transmitted to the opposite device. Each device accounts for received packets and “gates” transmission of packets based upon a credit limit. When space becomes free (packets are consumed by the core logic) a flow control update (FCU) may be generated for communication to the opposite device, for instance a flow control packet providing more credits. Packets are “gated” or in other words prevented from being transmitted to the opposite c-link device unless there is available space at the receiving device, as determined by the credit limit. In this manner, the devices may communicate without overflowing the available buffer/queue space.

In the implementation 400 of FIG. 4, a hold off module 210(1) is illustrated as incorporated within a link arbitration and symbol generator 440. Hold off module 210(1) may alternatively be provided as a standalone portion of controller 208(1) and/or an associated c-link device module. Link arbitration & symbol generator 440 represents functionality to arbitrate ownership of the interconnect 132, receive special packets such as a token 212 from the packet decoder 406, process the special packets, generate special packets, maintain a token 212 while an associated device has data to transmit, initiate or request the release of the token 212 to the opposite device under appropriate conditions, and so forth. Further, an associated hold off module 210(1) may be executed to delay release of the token 212 for a configurable time period to improve efficient communication on the c-link interconnect 132 when certain hold off conditions 432 are present. To implement token hold off techniques, the OR logical operator 434 operates to indicate a hold off condition 432 to the hold off module 210(1). As previously noted a variety of hold off conditions is contemplated; examples of which include pending flow control update 436 hold off or pending completions 438 hold off depicted in FIG. 4.

For instance, a device 202(1) may be permitted to hold off releasing the token 212 if there are pending transactions in the receiver queues 416, 418 of the c-link controller 208(1) where the transaction will be consumed by the core logic 204(1) relatively soon and a flow control update (FCU) from the flow control 430 system will be generated for communication to the opposite c-link device 202(2) via the interconnect 132. In other words, module 210(1) may detect that a FCU will be produced soon by monitoring the receiver queues 416, 418. Thus, the token hold-off which delays release of the token 212 by 8 to 32 idle bytes may allow time to consume the packets and produce the FCU, and may be more efficient than immediately releasing the token 212 when there is no data to transmit.

In another example, a device 202(1) may hold off the token when there is a pending completion to be returned. Generally, a completion (e.g., confirmation) is associated with each non-posted request to indicate the request has been processed and is returned to the requesting device as soon as possible after receiving the request, because the requesting device may be awaiting confirmation before proceeding to another task. Those requests categorized as non-posted requests include configuration reads and writes, input/output reads and writes and memory reads. Other transactions/requests may be categorized as posted requests and are generally processed without providing an associated completion to the requestor. Thus, the hold off module 210(1) may anticipate or understand that a completion is pending and delays token 212 release to allow the processing of the pending completion.

FIG. 4 further includes a clock domains key 442, which illustrates different shading for different speeds associated with components of the controller 208(1). As noted the ME 104 may have independent clocking. Further different devices in the ME 104 may operate at different speeds, which in the c-link interconnect 132 system may result in communications occurring at different speeds, which may be adjusted via a clock match 410 as noted. Different speeds are represented in FIG. 4 for components of controller 208(1) by shading which correspond to c-link receive 444 (speed of inbound packets), c-link transmit 446 (speed of outbound packets), and c-link core 448 (core logic speed).

FIG. 5 depicts exemplary implementation 500 of token hold off logic which may be associated with a c-link controller 208(1) in greater detail. The depicted hold off logic may be implemented via hold-off module 210(1), link arbitration & special symbol generator 440, a controller 208(1) and/or combinations thereof. When a hold off condition 432 such as flow control update 436 hold off or pending completions 438 hold off are identified or determined, a counter 502 portion may be executed. The counter 502 is illustrated as including functionality for the associated controller 208(1) to increment 504 the counter 502, and to clear 506 the counter 502, e.g., to reset. The counter 502 value is compared to a configurable hold or value 508 which may be predetermined and designates the time period for delaying of the token 212. The hold off value 508 may be programmed initially and may be later updated. A logical EQUALS operator 510 determines when the counter value 502 equals the hold off value 508, i.e., when the token hold off period expires. The output is provided to AND operator 512.

AND operator 512, determines when there is a hold off condition 432 provided from OR operator 434 (e.g., either flow control update 436 hold off or pending completions 438 hold off) and when the token hold off expires from EQUALS operator 510. Logical AND operator 514 links the inverse of a hold off condition 432 via INVERSE operator 516 and other hand-off conditions 518. Thus, AND operator 514 determines when there is no hold off condition, and when other token hand off conditions 518 exist. A variety of other hand off conditions 518 are contemplated such as when there is no current data to send. The output of AND operators 512 and 514 are combined by logical OR operator 520. The output of OR operator 520 goes to a token release request 522, which produces a request which causes the release of the token 212 to the opposite c-link device. For example, a hold-off module 210(1) may generate a request that the link arbitration & special symbol generator 440 release the token 212.

Thus, while there is a hold off condition 432, and the token hold period off has not expired, (via EQUAL operator 510), the counter 502 runs and the token 212 is maintained by the associated device. This is true even when there are other handoff conditions 518, such as there presently being no packets to transmit. Thus, under hold off condition 432, a token 212 release may be delayed for a designated time period, e.g., a hold off value 508.

The OR operator 520 will cause the token 212 to be released via token release request 522 based upon the output of either AND operator 512 or 514. Thus, when a hold off condition 432 exists and the token hold period off has expired per Equal operator 510, the result of AND operator 512 is true and the OR operator 520 causes the token 212 to be released via token release request 522. The release in this case occurs after the designated token hold off period, e.g. hold off value 508. When there is not a hold off condition 432 (e.g. INVERSE 516) and there are other handoff conditions 518, such as there presently being no packets to transmit, the result of AND operator 514 is true and the OR operator 520 causes the token 212 to be released via token release request 522. In this case, the token 212 may be released immediately or nearly immediately when the other handoff conditions 518 is determined.

### CONCLUSION

Although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

What is claimed is:

1. An apparatus comprising:
a chipset having a plurality of devices communicatively coupled via an interconnect that is operable to pass a token, between the devices, which permits a respective said device having the token to use the interconnect; and
a module associated with each of the devices to:
maintain the token at a respective said device while the device has data to transmit; and
when the respective said device does not have data to transmit, determine whether one or more token hold off conditions exist, and if so, delay release of the token to another said device for a predetermined time period.

2. An apparatus as recited in claim 1, wherein the token is released to the other device without delay when the respective said device does not have data to transmit and no hold off conditions are determined.

3. An apparatus as recited in claim 1, wherein the token is released when the predetermined time period expires.

4. An apparatus as recited in claim 1, wherein the predetermined time period is configurable between about eight and thirty-two idle bytes.

5. An apparatus as recited in claim 1, wherein:
the interconnect is a portion of a manageability engine of a host system which includes the chipset; and
the manageability engine is configured to provide manageability functions that are accessible independently of the host system power or operating state.

6. An apparatus as recited in claim 1, wherein the interconnect is a token based half-duplex communication interconnect.

7. An apparatus as described in claim 1, wherein the interconnect is configured to include a clock signal and a data signal.

8. An apparatus as described in claim 1, wherein the one or more hold off conditions are selected from a group consisting of a pending flow control update and a pending completion for a non-posted request.

9. An apparatus as described in claim 1, wherein the module is an integrated portion of a controller which is provided with each device to manage communication between the pair of interconnected devices and data packet flow within a respective device to be processed by the core logic of the device.

10. An apparatus as described in claim 9, wherein:
the controller utilizes credit based flow control; and
the module determines when a flow control update is pending, such that the release of the token may be delayed based upon the pending flow control update.

11. An apparatus as described in claim 10, wherein determining when a flow control update is pending includes examining a receiver queue of the controller to identify pending transactions, which when consumed by the core logic result in the flow control update via the credit based flow control.

12. An apparatus as described in claim 9, wherein the controller includes a non-posted queue for non-posted requests which when processed cause communication of a completion to the requesting device; and
the determining of one or more hold of conditions includes determining if a completion associated with a non-posted request in the queue is pending, such that the release of the token may be delayed based upon determination of a pending completion.

13. An apparatus as described in claim 1, wherein the plurality of devices are selected from the group consisting of:
a memory controller;
a memory controller device;
an input/output controller; and
an input/output device.

14. An apparatus as described in claim 1, wherein the plurality of devices includes at least a memory controller and an input/output controller communicatively coupled via the interconnect.

15. An apparatus comprising:
a host partition having a processor and a processor interface interconnect to interconnect components in the host partition;
a manageability engine in a partition separate from the host partition and operable to provide manageability functions independent of the host partition;
a controller link interconnect system interconnecting a plurality of devices in the manageability engine; and
a controller, associated with the plurality of interconnected devices in the manageability engine, to:
receive a token at one said device to enable the device to transmit via a interconnect between the plurality of devices; and
when one or more hold off conditions exist, delay release of the token to another said device for a predetermined period of time.

16. An apparatus as described in claim 15, wherein the controller link interconnect system is a token based half duplex communication link, which is accessible out of band from the host partition and operable on auxiliary system power.

17. An apparatus as described in claim 15, wherein the one or more hold off conditions are selected from the group consisting of a pending flow control update; and a pending completion for a non-posted request.

18. An apparatus as recited in claim 15, wherein the controller releases the token to the other device of the pair without delay when the one said device does not have data to transmit and hold off conditions do not exist.

19. An apparatus as recited in claim 15, wherein the predetermined period of time is configurable between about eight and thirty-two idle bytes.

20. A method comprising:
receiving a token at a first device from a second device via an interconnect, wherein the first and second devices form a portion of a manageability engine of a chipset within a host system;
maintaining the token while the first device has data to transmit via the interconnect; and
when the first device does not have data to transmit, determining whether one or more token hold off conditions exist, and if so, delaying release of the token to the second device for a programmed time period.

21. A method as recited in claim 20 further comprising releasing the token to the second device when the first device does not have data to transmit and when hold off conditions are not determined to exist.

22. A method as recited in claim 20, wherein the first device and a second device are configured to pass the token back and forth such that one of the devices at a particular point in time is able to transmit via the interconnect while possessing the token.

23. A method as recited in claim 20, wherein the manageability engine is to provide manageability functions that are accessible independently of the host system power or operating state.

24. A method as recited in claim 20, wherein the one or more hold off conditions are selected from the group consisting of a pending flow control update and a pending completion for a non-posted request.
